(19) United States
(12) Patent Application Publication
(10) Pub. No.: US 2024/0067353 A1
(43) Pub. Date: Feb. 29, 2024

(54) Supersonic Inlet Systems

(71) Applicant: Gecheng Zha, Cutler Bay, FL (US)

(72) Inventor: Gecheng Zha, Cutler Bay, FL (US)

(21) Appl. No.: 18/085,946

(22) Filed: Dec. 21, 2022

Related U.S. Application Data
(60) Provisional application No. 63/295,540, filed on Dec. 31, 2021.

(51) Int. Cl. B64D 33/02

(52) U.S. Cl. CPC B64D 33/02; B64D 2033/026

(57) ABSTRACT

Inlet systems are described. An example inlet system has a first wall, a second wall, and a compressor. The first wall has a first end, a second end, and defines a passageway, a first passageway opening, and a second passageway opening. The passageway extends from the first passageway opening to the second passageway opening. The first wall and the second wall cooperatively define an inlet, an outlet, and a channel. The channel extends from the inlet to the outlet. The compressor is disposed within the passageway and is configured to pressurize fluid that passes through the passageway. The first end of the first wall is disposed outside of the channel. The passageway is in fluid communication with the channel.

### RELATED APPLICATION

This application claims the benefit of U.S. Provisional Application No. 63/295,540, filed Dec. 31, 2021. The entire disclosure of this related application is hereby incorporated into this disclosure by reference.

### FIELD

The disclosure relates generally to the field of fluid systems. More particularly, the disclosure relates to supersonic inlet systems.

### BACKGROUND

Supersonic aircrafts (e.g., those traveling at speeds greater than Mach 1) require that the speed of the air entering the engines be slowed down such that the engines can properly generate thrust. Conventionally, this is accomplished using one of two types of inlet systems, an axisymmetric inlet system or a rectangular inlet system. Axisymmetric inlet systems are currently used more often in military supersonic aircrafts, such as the SR-71, which can travel at Mach 3. Since jet engine interfaces are axisymmetric, an axisymmetric inlet system corresponds to the engine interface reducing the overall weight of the inlet system relative to rectangular inlet systems. Rectangular inlet systems are currently used more often on supersonic civilian transports, such as the Concorde, which can travel at Mach 2. A transition portion is generally used to transition between a rectangular inlet system and an engine interface, which increases the overall weight of the inlet system relative to axisymmetric inlet systems.

FIGS. 1 through 3 illustrate an example axisymmetric inlet 10 that has a lengthwise axis 11, a first wall 12, and a second wall 14. The first wall 12 has a first end 16, a second end 18, and defines a first portion 20, a second portion 22, and a third portion 24. The first portion 20 extends toward the second wall 14 from the first end 16 to the second portion 22. The second portion 22 extends away from the second wall 14 from the first portion 20 to the third portion 24. The third portion 24 is disposed a distance 25 from the second wall 14 that increases from the second portion 22 towards the second end 18 of the first wall 12. This structural arrangement results in a gradually increasing cross-sectional area, which decelerates the flow of fluid (e.g., subsonic flow) through the channel 30, as described in more detail below. The first wall 12 and the second wall 14 cooperatively define an inlet 26, an outlet 28, and a channel 30. The channel 30 extends from the inlet 26 to the outlet 28. The outlet 28 is in fluid communication with an engine, which can be a turbo-engine, a ramjet engine, a scramjet engine, or any other engine that increases the energy of the flow traveling through the engine. The first end 16 of the first wall 12 is disposed outside of the channel 30. This structural configuration forms an external compressions area to compress and decelerate air flow as it enters the inlet 26. The supersonic flow continues to decelerate after passing the inlet 26 until the flow reaches the minimum area of the channel (e.g., throat portion 66), which can be positioned at any location relative to the inlet 56 such as at an inlet or downstream from an inlet.

In the example shown, the first wall 12 is a center body 34 and the second wall 14 is a cowl 36. The center body 34 has a circumference that entirely encircles the lengthwise axis 11 such that the first portion 20 defines an outside diameter 21 that increases from the first end 16 to the second portion 22, the second portion 22 defines an outside diameter 23 that decreases from the first portion 20 to the third portion 24 to form a diverging channel with the second wall 14, and the third portion 24 has an outside diameter 27 that gradually decreases forming a gradual diverging portion of the channel 30. The cowl 36 entirely encircles the lengthwise axis 11 and defines a channel 38 within which the center body 34 is disposed. The cowl 36 can have a diameter variation along the lengthwise axis 11 to form a convex shape, a concave shape, or a constant shape.

FIGS. 4 through 6 illustrate an example rectangular inlet 40 that has a lengthwise axis 41, a first wall 42, and a second wall 44. The first wall has a first end 46, a second end 48, and defines a first portion 50, a second portion 52, and a third portion 54. The first portion 50 extends toward the second wall 44 from the first end 46 to the second portion 52. The second portion 52 extends away from the second wall 44 from the first portion 50 to the third portion 54. The third portion 54 is disposed a distance 55 from the second wall 44 that increases from the second portion 52 towards the second end 48 of the first wall 42. The first wall 42 and the second wall 44 cooperatively define an inlet 56, an outlet 58, and a channel 60. The channel 60 extends from the inlet 56 to the outlet 58. The outlet 58 is in fluid communication with an engine. The first end 46 of the first wall 42 is disposed outside of the channel 60. This structural configuration forms an external compressions area to compress and decelerate air flow as it enters the inlet 56. The supersonic flow continues to decelerate after passing the inlet 56 until the flow reaches the minimum area of the channel (e.g., throat portion 66), which can be positioned at any location relative to the inlet 56.

The external compression area provided by these inlet systems 10, 40 aerodynamically slows down the flow of air entering the channel and ultimately entering the engine. As shown in FIG. 7, the inlet working condition is categorized by the position of a terminal shock wave 64. If the terminal shock wave 64 is positioned downstream of a throat portion 66 (a location where there is a minimum distance between the first and second walls 12,42 14,44), as shown by line 68, the working condition is a supercritical condition. If the terminal shock wave 64 is at the throat portion 66, as shown by line 70, the working condition is a critical condition. If the terminal shock wave 64 is positioned upstream of an inlet 26, 56 (e.g., the entrance to the channel 30, 60), as shown by line 72, the working condition is a subcritical condition. To increase efficiency, the terminal shock should be stable at the critical condition at, or in the vicinity, of the throat portion 66. However, in some cases the critical condition at an inlet 26, 56, may not be stable. For example, some disturbances, such as variations in an angle of attack, may push the shock wave 64 upstream of an inlet 26, 56 to a subcritical condition 72, which reduces engine thrust and introduces high instability. The supercritical condition 68 is generally more stable, but can have high energy losses.

Current inlet systems, such as axisymmetric inlet systems 10 and rectangular inlet systems 40, utilize bleed or bypass technology to increase the stability range in order to maintain the inlets at their critical conditions. As shown in FIG. 7, an inlet bleed 74, 76, 78 can be positioned at a variety of locations to increase the inlet stability at the critical condition. For example, an inlet bleed 74, 76 can be positioned on a first wall 12, 42 and/or an inlet bleed 78 can be positioned on a second wall 14, 44. An inlet bleed 74, 76 on a first wall 12, 42 can be positioned at a variety of locations on the first wall 12, 42. For example, the inlet bleed 74 can be positioned at a throat portion 66, or near a throat portion 66. Alternatively, the inlet bleed 76 can be positioned downstream from the throat portion 66. An inlet bleed 78 can also be positioned on a second wall 14, 44 which is also referred to as a bypass bleed.

When positioned on a first wall 12, 42, the inlet bleed 74, 76 withdraws mass flow from the inlet 26, 56 thinning the wall boundary layer and opening the inlet 26, 56 area to stabilize the shock wave 64 at the throat portion 66 for critical condition. Typically, the bleed air is dumped into ambient air (e.g., outside of the inlet, engine) and will cause an overall system energy loss and thrust reduction. Utilizing inlet bleeds increases the overall weight of the system and reduces aircraft system efficiency. Alternative to utilizing inlet bleeds, some inlet systems utilize a translatable first body (e.g., center body) that can translate along a lengthwise axis of the first body, which may slightly stabilize a shock wave. While various options have been developed for addressing disturbances, improved inlet systems are desired to increase the overall efficiency of an inlet system and stabilize the terminal shock wave of the inlet system.

Therefore, a need exists for new and useful supersonic inlet systems.

### Summary of Selected Example Embodiments

Various supersonic inlet systems are described.

An example inlet system has a first wall, a second wall, and a compressor. The first wall has a first end, a second end, and defines a passageway, a first passageway opening, and a second passageway opening. The passageway extends from the first passageway opening to the second passageway opening. The first wall and the second wall cooperatively define an inlet, an outlet, and a channel. The channel extends from the inlet to the outlet. The compressor is disposed within the passageway and is configured to pressurize fluid that passes through the passageway. The first end of the first wall is disposed outside of the channel. The passageway is in fluid communication with the channel.

Another example inlet system has a first wall and a second wall. The first wall has a first end, a second end, and defines an inner surface, a passageway, a first passageway opening, and a second passageway opening. The passageway extends from the first passageway opening to the second passageway opening. The first passageway opening is defined on the inner surface between the first end of the first wall and the second passageway opening. The second passageway opening is defined on the inner surface between the first passageway opening and the second end of the first wall. The first wall and the second wall cooperatively define an inlet, an outlet, and a channel. The channel extends from the inlet to the outlet. The first end of the first wall is disposed outside of the channel. The passageway is in fluid communication with the channel.

An example supersonic inlet system for an engine has a first wall, a second wall, and a compressor. The first wall has a first end, a second end, and defines an inner surface, a passageway, a first passageway opening, and a second passageway opening. The passageway extends from the first passageway opening to the second passageway opening. The first passageway opening is defined on the inner surface between the first end of the first wall and the second passageway opening. The second passageway opening is defined on the inner surface between the first passageway opening and the second end of the first wall. The first wall and the second wall cooperatively define an inlet, an outlet, and a channel. The channel extends from the inlet to the outlet. The compressor is disposed within the passageway and is configured to pressurize fluid that passes through the passageway. The first end of the first wall is disposed outside of the channel. The passageway is in fluid communication with the channel.

Another example supersonic inlet system for an engine has a first wall, a second wall, and a compressor. The first wall has a first end, a second end, and defines an inner surface, a passageway, a first passageway opening, and a second passageway opening. The passageway extends from the first passageway opening to the second passageway opening. The first passageway opening is defined on the inner surface between the first end of the first wall and the second passageway opening. The second passageway opening is defined on the inner surface between the first passageway opening and the second end of the first wall. The first passageway opening has a first width and the second passageway opening has a second width. The first wall and the second wall cooperatively defining an inlet, an outlet, and a channel. The inlet having an inlet height (h). The channel extends from the inlet to the outlet. The compressor is disposed within the passageway and is configured to pressurize fluid that passes through the passageway. The first width is between about 0.01% h and about 10 h. The second width is between about 0.01% h and about 20 h. The first end of the first wall is disposed outside of the channel. The passageway is in fluid communication with the channel.

Additional understanding of these example inlet systems can be obtained by review of the detailed description, below, and the appended drawings.

### BRIEF DESCRIPTION OF THE DRAWINGS

FIG. 1 is a partial perspective view of an example prior art axisymmetric supersonic inlet system.

FIG. 2 is another partial perspective view of the prior art axisymmetric supersonic inlet system illustrated in FIG. 1.

FIG. 3 is a sectional view of the prior art axisymmetric supersonic inlet system illustrated in FIG. 2 taken along line A-A.

FIG. 4 is a partial perspective view of an example prior art rectangular supersonic inlet system.

FIG. 5 is another partial perspective view of the prior art rectangular supersonic inlet system illustrated in FIG. 4.

FIG. 6 is a sectional view of the prior art rectangular supersonic inlet system illustrated in FIG. 5 taken along line B-B.

FIG. 7 is a sectional view of a prior art supersonic inlet system taken along the lengthwise axis of the inlet system.

FIG. 8 is a sectional view of an example supersonic inlet system that includes a co-flow jet taken along the lengthwise axis of the inlet system.

FIG. 9 is a sectional view of another example supersonic inlet system that includes a co-flow jet taken along the lengthwise axis of the inlet system.

### DETAILED DESCRIPTION

The following detailed description and the appended drawings describe and illustrate various example embodiments of supersonic inlet systems. The description and illustration of these examples are provided to enable one skilled in the art to make and use a supersonic inlet system. They are not intended to limit the scope of the claims in any manner.

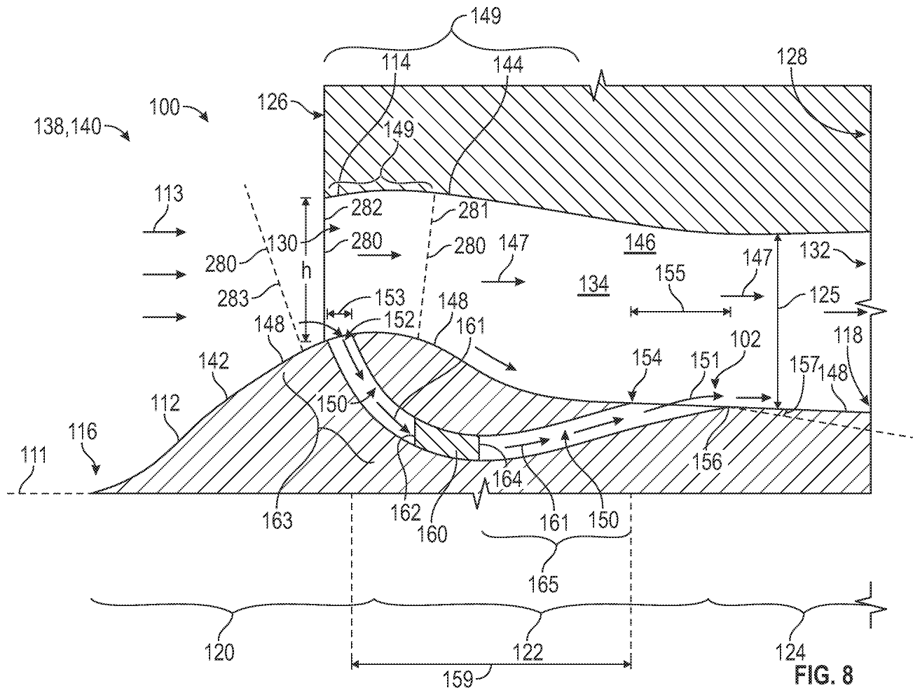

FIG. 8 illustrates a first example supersonic inlet system 100 that includes a co-flow jet 102. The system 100 has a lengthwise axis 111, a first wall 112, a second wall 114, and a compressor 160. As shown in FIG. 8, the freestream velocity 113 is greater than the speed of sound, or the freestream Mach number is greater than 1.

The first wall 112 has a first end 116, a second end 118, and defines a first portion 120, a second portion 122, and a third portion 124. The first portion 120 extends toward the second wall 114 from the first end 116 to the second portion 122. The second portion 122 extends away from the second wall 114 from the first portion 120 to the third portion 124. The third portion 124 is disposed a distance 125 from the second wall 114 that increases from the second portion 122 towards the second end 118 of the first wall 112. This structural arrangement results in a gradually increasing cross-sectional area, which decelerates the flow of fluid (e.g., subsonic flow) through the channel 134, as described in more detail below. The second wall 114 has a first end 126 and a second end 128. The first wall 112 and the second wall 114 cooperatively define an inlet 130, an outlet 132, and a channel 134. The channel 134 extends from the inlet 130 to the outlet 132. The outlet 132 is in fluid communication with an engine. The first end 116 of the first wall 112 is disposed outside of the channel 134. This structural configuration forms an external compressions area to compress and decelerate air flow as it enters the inlet 130. The supersonic flow continues to decelerate after passing the inlet 130 until the flow reaches the throat portion 149, as described in more detail below, which can be disposed at any suitable location relative to an inlet, such as at an inlet, or downstream to an inlet.

The supersonic inlet system 100 can be included on an inlet system having any suitable cross-sectional shape, such as an axisymmetric inlet system 138, a rectangular inlet system 140, an inlet with an elliptic cross-section, or any other cross-sectional shape. In embodiments in which the supersonic inlet system 100 is an axisymmetric inlet system 138, the first wall 112 is a center body 142 and the second wall 114 is a cowl 144. The center body 142 has a circumference that entirely encircles the lengthwise axis 111 such that the first portion 120 defines an outside diameter that increases from the first end 116 to the second portion 122, the second portion 122 defines an outside diameter that decreases from the first portion 120 to the third portion 124, and the third portion 124 has an outside diameter that gradually decreases, resulting in a gradually increasing cross-sectional area. The cowl 144 entirely encircles the lengthwise axis 111 and defines a channel 146 within which the center body 138 is disposed.

In the illustrated embodiment, the first wall 112 defines an inner surface 148 and a passageway 150. The passageway 150 extends from a first passageway opening 152 to a second passageway opening 154 and is in fluid communication with the channel 134. A throat portion 149 of the channel 134 is disposed at a location where there is a minimum distance between the first and second walls 112, 114. A throat portion can be disposed at any suitable location on an inlet system, such as on an axis disposed orthogonal to a lengthwise axis and that includes an inlet, or downstream from an inlet.

A supersonic inlet system 100 can define a passageway using any suitable structure and/or structural arrangement. For example, a supersonic inlet system can include a wall that defines a passageway. Alternatively, a first portion of a wall can define a recess that receives a portion, or the entirety, of a second portion of the wall that cooperatively defines the passageway with the first portion of the wall. The second portion of the wall can be attached to the first portion of the wall using any suitable method and/or technique of attachment.

The first passageway opening 152 has a first width 153 measured parallel to the lengthwise axis 111 and first cross-sectional area. The second passageway opening 154 has a second width 155 measured parallel to the lengthwise axis 111 and a second cross-sectional area that is less than the first cross-sectional area. However, alternative embodiments can include a second passageway opening that has a second cross-sectional area that is greater than, or equal to, a first cross-sectional area. The first passageway opening 152 is defined on the inner surface 148 and is disposed between the first end 116 of the first wall 112 and the second passageway opening 154. In the illustrated embodiment, the first passageway opening 152 is disposed adjacent to the inlet 130 and tangential to the inner surface 148. However, alternative embodiments can include a first passageway opening disposed at any suitable location and at any suitable angle relative to a wall.

The first width 153 and/or second width 155 can be any suitable width and selection of a suitable width can be based on various considerations, such as the mass flow rate intended to be passed through a passageway such that sufficient mass flow to stabilize a shock wave with sufficient operation margin without the inlet flow moving to a subcritical condition, as described herein. Examples of first widths considered suitable for a first passageway opening include those between about 0.01% h and about 10 h, between about 10% h and about 100% h, where h is the inlet height, as shown in FIG. 8. Examples of second widths considered suitable for a second passageway opening include those between about 0.01% h and about 20 h where h is the inlet height, as shown in FIG. 8.

While the first passageway opening 154 has been illustrated as being disposed on the first wall, alternative embodiments can include a first passageway opening on the second wall and positioned at any suitable location, such as those described with respect to the first passageway opening 154. In these alternative embodiments, a passageway will extend from a first passageway opening defined on the second wall to a second passageway opening defined on the first wall. This can be accomplished by defining a portion of the passageway through, or adjacent to, a strut connecting a first wall to a second wall.

In addition, alternative embodiments, can include a first passageway opening that is disposed within a throat portion, a first passageway opening that is disposed between a first axis that is orthogonal to a lengthwise axis of an inlet system and includes a first end of a second wall and a second axis that is orthogonal to the lengthwise axis and includes a third portion of a first wall, a first passageway opening that is disposed on an axis that is orthogonal to a lengthwise axis of an inlet system and includes a first end of a second wall, a first passageway opening that is disposed on an axis that is disposed at an angle to a lengthwise axis of an inlet system and includes a first end of a second wall, a first passageway opening that is disposed between a first axis that is orthogonal to a lengthwise axis of an inlet system and includes a first end of a second wall and a second axis that is orthogonal to the lengthwise axis and includes a first end of a first wall, or a first passageway opening that is disposed downstream to an axis that is orthogonal to a lengthwise axis of an inlet system and includes a first end of a second wall.

The second passageway opening 154 is defined on the inner surface 148 and is disposed between the first passageway opening 152 and the second end 118 of the first wall 112 such that fluid can enter the passageway 150 through the first passageway opening 152, pass through the passageway 150, and exit the passageway 150 through the second passageway opening 154. In the illustrated embodiment, the second passageway opening 154 is disposed adjacent to a junction 156 between the second portion 122 and the third portion 124. Alternative embodiments, however, can include a second passageway opening that is disposed on a first portion of a first wall, on a second portion of a first wall, on a third portion of a first wall, between first and second portions of a first wall, or between second and third portions of a first wall.

The second passageway opening 156 is separated from the first passageway opening 154 by a distance 159 that extends from the first passageway opening 154 to the second passageway opening 156. For example, the second passageway opening 156 is located at a position in which the fluid flow 147 through the channel 146 is subsonic. The distance 159 can be any suitable distance, such as distances in which a second passageway opening is closer to a first passageway opening than a second end of a first wall, a second passageway opening is closer to a first passageway opening than an engine, distances equal to, about, less than, or greater than 0.1 h, 50 h, or between about 0.1 h and about 50 h, where h is the height of the channel 146 at the inlet 130, or any other location along the length of the channel 146.

While the second passageway opening 156 has been illustrated as being disposed on the first wall, alternative embodiments can include a second passageway opening on the second wall and positioned at any suitable location, such as those described with respect to the second passageway opening 156. In these alternative embodiments, a passageway will extend from a first passageway opening defined on the first wall to a second passageway opening defined on the second wall. This can be accomplished by defining a portion of the passageway through, or adjacent to, a strut connecting a first wall to a second wall. Furthermore, while the second passageway opening 156 has been illustrated as being disposed between the first passageway opening 154 and the second end 118 of the first wall 112 (e.g., downstream of the first passageway opening, in a subsonic region), alternative embodiments can include a second passageway opening that is disposed between a first end of a first wall and a first passageway opening (e.g., upstream of a first passageway opening, in a supersonic region). Alternative embodiments can also include a passageway, a first passageway opening, and a second passageway opening on a second wall and positioned as described herein with respect to the passageway 150, the first passageway opening 152, and the second passageway opening 154.

The first passageway opening 152 and the second passageway opening 154 can have any suitable shape and selection of a suitable shape can be based on various considerations, including the desired fluid flow through a passageway defined by a wall of a supersonic inlet system. Examples of suitable shapes for a passageway opening include circular, oval, elliptical, rectangular, wavy (e.g., such that the opening defines a plurality of peaks and troughs), and any other geometric shape considered suitable for a particular embodiment.

While the first passageway opening 152 and the second passageway opening 154 have been illustrated as a single opening providing access to the passageway 150, in alternative embodiments a first passageway opening and/or second passageway opening can comprise a plurality of passageway openings, each being a discrete opening providing access to a passageway, and positioned as described with respect to the first passageway opening 152 and/or second passageway opening 154.

In the illustrated embodiment, a portion of the first wall 112 that defines the second passageway opening 154 is disposed at a first angle 157 relative to the inner surface 148 such that fluid 151 exiting the passageway 150 at the second passageway opening 154 is directed toward the outlet 132 (e.g., such that fluid 151 exiting the passageway 150 at the second passageway opening 154 is directed tangential to the flow of fluid 147 through the channel 146 and/or tangential to the inner surface 148). In the illustrated embodiment, the first angle is between about 0 degrees and about 90 degrees and is measured along a plane that contains the lengthwise axis. Alternative embodiments, however, can define a second passageway opening such that it is disposed at a first angle relative to the inner surface such that fluid exiting the passageway at the second passageway opening is directed toward the second wall, toward the second end of a second wall, toward a second end of a first wall, or toward fluid traveling through a channel.

The compressor 160 is disposed within the passageway 150 and provides a mechanism for pressurizing the fluid 161 passing through the passageway 150 during use. In alternative embodiments, a compressor can comprise a plurality of compressors disposed along a circumference of a centerbody at the inlet. In the illustrated embodiment, the compressor 160 is disposed a first distance from the first passageway opening 152 when traveling through the passageway 150 from the first passageway opening 152 to the compressor 160 and a second distance from the second passageway opening 154 when traveling through the passageway 150 from the compressor 160 to the second passageway opening 154. The first distance is less than the second distance. However, alternative embodiments can include a compressor in which the first distance is greater than, or equal to, the second distance. A first portion 163 of the passageway 150 extends from the first passageway opening 152 to the compressor 160 and a second portion 165 of the passageway 150 extends from the compressor 160 to the second passageway opening 154. The first and second portions 163, 165 of the passageway 150 can have any suitable structural arrangement. For example, each of the first and second portions 163, 165 can have a circular end that interfaces with the compressor 160 and any suitable structural arrangement interfacing with the inner surface 148. For example, any suitable shape that provides a maximum stability of the inlet shock wave system at the critical condition and minimum total pressure loss. Examples of suitable structural arrangements for first and second portions includes circle-to-circle, rectangle-to-circle, a sector formed by two concentric circles transitioning to circles, or any variation of the configurations described herein.

A compressor included in a supersonic inlet system can comprise any suitable device, system, or component capable of pressurizing fluid and selection of a suitable compressor can be based on various considerations, such as the structural arrangement of a passageway within which a compressor is intended to be disposed. Examples of compressors considered suitable to include in a supersonic inlet system include electric pumps, pneumatic pumps, hydraulic pumps, micro-pumps, fans, compressors, micro-compressors, vacuums, blowers, and any other compressor considered suitable for a particular embodiment. In the illustrated embodiment, the compressor 160 is a micro-compressor.

In the illustrated embodiment, the compressor 160 is disposed (e.g., entirely) within the passageway 150, is moveable between an off state and an on state, and has a suction port 162 and a discharge port 164. It is considered advantageous to include a compressor 160 in a passageway 150 defined by a supersonic inlet system 100 at least because the inclusion of a compressor 160 provides a mechanism for pressurizing fluid that passes through the passageway 150 such that it forms a jet as the fluid exits the second passageway opening 154, forming a co-flow jet 102. This is considered advantageous at least because it provides a mechanism for stabilizing the normal shock wave of a supersonic inlet.

The compressor 160 can be operatively connected to any suitable portion of a supersonic inlet system 100 and/or the device, system, or component on which the supersonic inlet system 100 is disposed to provide power to the compressor (e.g., battery, electric motor) and to provide a mechanism for moving the compressor between the off state and the on state (e.g., one or more switches). Alternative embodiments can include a compressor that can vary the degree to which fluid is pressurized through the passageway 150. Examples of mass flow rates considered suitable to pass through a passageway (e.g., passageway 150, when the compressor 160 is in an on state) and/or a passageway opening (e.g., first passageway opening 152, second passageway opening 154) include mass flow rates that are greater than, less than, or equal to 0.01%, 0.05%, 0.1%, 0.5%, 1%, 5%, 10%, 20%, 30%, 40%, 50% of the mass flow rate passing through an inlet (e.g., inlet 130), between about 0.1% and about 5% of the mass flow rate passing through an inlet (e.g., inlet 130), and any other mass flow rates considered suitable for a particular embodiment.

The compressor 160 is attached to the first wall 112 and is positioned such that the suction port 162 is directed toward a first portion of the passageway that extends from the first passageway opening 152 to the compressor 160 (e.g., the suction port 162 is directed toward the first passageway opening 152) and the discharge port 164 is directed toward a second portion of the passageway that extends from the second passageway opening 154 to the compressor 160 (e.g., the discharge port 164 is directed toward the second passageway opening 154). In the off state, the compressor 160 does not pressurize fluid passing through the passageway 150. In the on state, the compressor 160 draws fluid through the suction opening 162, through the compressor 160, and pushes fluid out of the discharge port 164 and the second passageway opening 154. When in the on state, the fluid entering the passageway 150 at the first passageway opening 152 has a first velocity and the fluid exiting the passageway 150 at the second passageway opening 154 has a second velocity that is greater than the first velocity and is directed toward the outlet 132. In alternative embodiments, however, a second velocity can be less than, or equal to, a first velocity. In addition, the fluid entering the passageway 150 at the first passageway opening 152 has a first pressure and the fluid exiting the passageway 150 at the second passageway opening 154 has a second pressure that is greater than the first pressure. In alternative embodiments, however, a second pressure can be less than, or equal to, a first pressure.

A compressor can be attached to a first wall using any suitable technique or method of attachment and selection of a suitable technique or method of attachment between a compressor and a first wall can be based on various considerations, including the material(s) that forms the compressor and/or the first wall. Example techniques and methods of attachment considered suitable include welding, fusing, using adhesives, mechanical connectors, and any other technique or method considered suitable for a particular embodiment. In the illustrated embodiment, the compressor 160 is attached to the first wall 112 using mechanical connectors (e.g., screws, bolts). While a compressor 160 has been illustrated in the supersonic inlet system 100, alternative embodiments can omit the inclusion of a compressor.

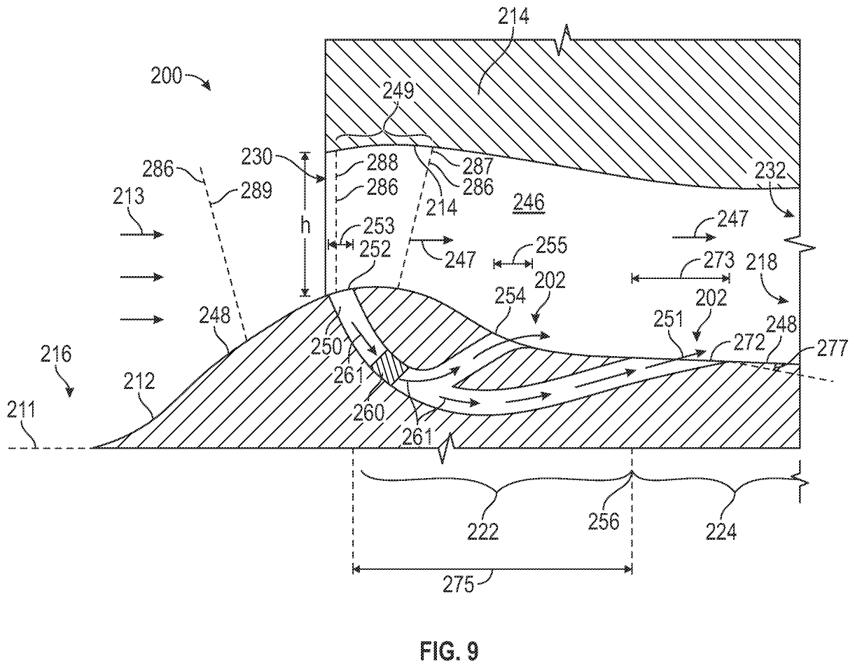

FIG. 9 illustrates a second example supersonic inlet system 200 that includes a co-flow jet 202. The system 200 is similar to the system 100 illustrated in FIG. 8 and described above, except as detailed below. The system 200 has a lengthwise axis 211, a first wall 212, a second wall 214, and a compressor 260. As shown in FIG. 9, the freestream velocity 213 is greater than the speed of sound, or the freestream Mach number is greater than 1.

In the illustrated embodiment, the first wall 212 defines an inner surface 248 and a passageway 250. The passageway 250 extends from a first passageway opening 252 to a second passageway opening 254 and a third passageway opening 272. A supersonic inlet system 200 can define a passageway using any suitable structure and/or structural arrangement. For example, a supersonic inlet system can include a wall that defines a passageway, a first passageway opening, a second passageway opening, and a third passageway opening. Alternatively, a first portion of a wall can define a recess that receives a portion, or the entirety, of a second portion of the wall that cooperatively defines a passageway, a first passageway opening, a second passageway opening, and a third passageway opening with the first portion of the wall. The second portion of the wall can be attached to the first portion of the wall using any suitable method and/or technique of attachment.

The third passageway opening 272 has a width 273 and a cross-sectional area. The third passageway opening 272 can have any suitable cross-sectional area, such as a cross-sectional area that is greater than, less than, or equal to the cross-sectional area of the first passageway opening 252 and/or the second passageway opening 254. The third passageway opening 272 can have any suitable width 273, such as a width that is greater than, less than, or equal to the width 253 of the first passageway opening 252 and/or the width 255 of the second passageway opening 254.

The first passageway opening 252 is defined on the inner surface 248 and is disposed between the first end 216 of the first wall 212 and the second passageway opening 254. In the illustrated embodiment, the first passageway opening 252 is disposed adjacent to the inlet 230 and is tangential to the inner surface 248. The second passageway opening 254 is defined on the inner surface 248 and is disposed between the first passageway opening 252 and the third passageway opening 272. The third passageway opening 272 is defined on the inner surface 248 and is disposed between the second passageway opening 254 and the second end 218 of the first wall 212 such that fluid can enter the passageway 250 through the first passageway opening 252, pass through the passageway 250, and exit the passageway 250 through one of the second passageway opening 254 or the third passageway opening 272. In the illustrated embodiment, the second passageway opening 254 is disposed on the second portion 222 and the third passageway opening 272 is disposed adjacent to a junction 256 between the second portion 222 and the third portion 224. Alternative embodiments, however, can include a third passageway opening that is disposed on a first portion of a first wall, on a second portion of a first wall, on a third portion of a first wall, between first and second portions of a first wall, or between second and third portions of a first wall.

The third passageway opening 272 is separated from the first passageway opening 254 by a distance 275 that extends from the first passageway opening 254 to the third passageway opening 272 and is measured parallel to the lengthwise axis 211. For example, the third passageway opening 272 is located at a position in which the fluid flow 247 through the channel 246 is subsonic. The distance 275 can be any suitable distance, such as distances in which a third passageway opening is closer to a first passageway opening than a second end of a first wall, a third passageway opening is closer to a first passageway opening than an engine, distances equal to, about, less than, or greater than 0.1 h, 50 h, or between about 0.1 h and about 50 h, where h is the height of the channel 146 inlet or any other portion of the channel.

While the third passageway opening 272 has been illustrated as being disposed on the first wall, alternative embodiments can include a third passageway opening on the second wall and positioned at any suitable location, such as those described with respect to the second passageway opening 256 and/or third passageway opening 272. In these alternative embodiments, a passageway will extend from a first passageway opening defined on the first wall to a third passageway opening defined on the second wall. This can be accomplished by defining a portion of the passageway through, or adjacent to, a strut connecting a first wall to a second wall. Furthermore, while the third passageway opening 272 has been illustrated as being disposed between the second passageway opening 254 and the second end 218 of the first wall 212 (e.g., downstream of the first passageway opening, in a subsonic region), alternative embodiments can include a third passageway opening that is disposed between a first end of a first wall and a first passageway opening (e.g., upstream of a first passageway opening, in a supersonic region).

The first passageway opening 252, the second passageway opening 254, and the third passageway opening 272 can have any suitable shape and selection of a suitable shape can be based on various considerations, including the desired fluid flow through a passageway defined by a wall of a supersonic inlet system. Examples of suitable shapes for a passageway opening include circular, oval, elliptical, rectangular, wavy (e.g., such that the opening defines a plurality of peaks and troughs), and any other geometric shape considered suitable for a particular embodiment.

While the first passageway opening 252, the second passageway opening 254, and the third passageway opening 272 have been illustrated as a single opening providing access to the passageway 250, in alternative embodiments a first passageway opening, a second passageway opening, and/or a third passageway opening can comprise a plurality of passageway openings, each being a discrete opening providing access to a passageway, and positioned as described with respect to the passageway openings described herein.

In the illustrated embodiment, a portion of the first wall 212 that defines the third passageway opening 272 is disposed at a second angle 277 relative to the inner surface 248 such that fluid 279 exiting the passageway 250 at the third passageway opening 272 is directed toward the outlet 232 (e.g., such that fluid 251 exiting the passageway 250 at the third passageway opening 272 is directed tangential to the flow of fluid 247 through the channel 246 and/or tangential to the inner surface 248). In the illustrated embodiment, the second angle is between about 0 degrees and about 90 degrees and is taken along a plane that contains the lengthwise axis 211. Alternative embodiments, however, can define a third passageway opening such that it is disposed at a second angle relative to the inner surface such that fluid exiting the passageway at the third passageway opening is directed toward a second wall, toward a second end of a second wall, toward a second end of a first wall, or toward fluid traveling through a channel.

The compressor 260 is disposed within the passageway 250 and provides a mechanism for pressurizing the fluid 261 passing through the passageway 250 during use. In the illustrated embodiment, the compressor 260 is disposed a first distance from the first passageway opening 252 when traveling through the passageway 250 from the first passageway opening 252 to the compressor 260 and a third distance from the third passageway opening 272 when traveling through the passageway 250 from the compressor 260 to the third passageway opening 272. The first distance is less than the third distance. However, alternative embodiments can include a compressor in which the first distance is greater than, or equal to, the third distance.

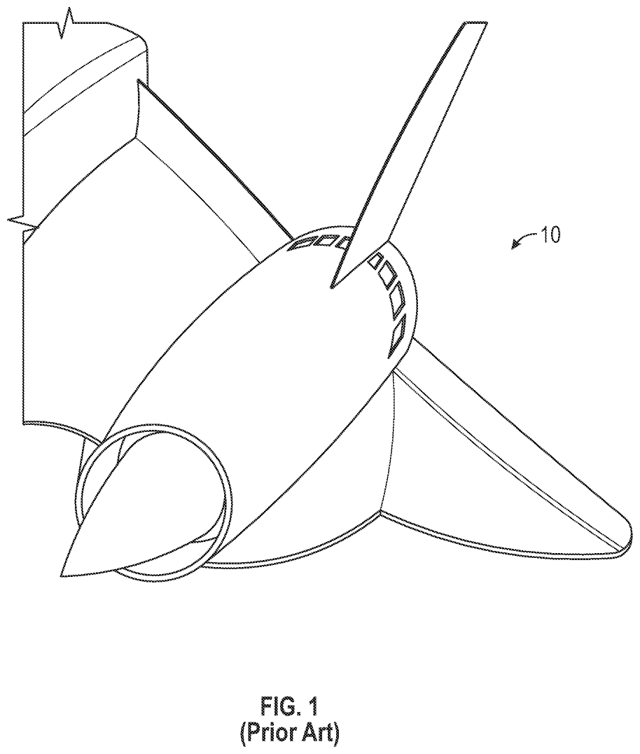

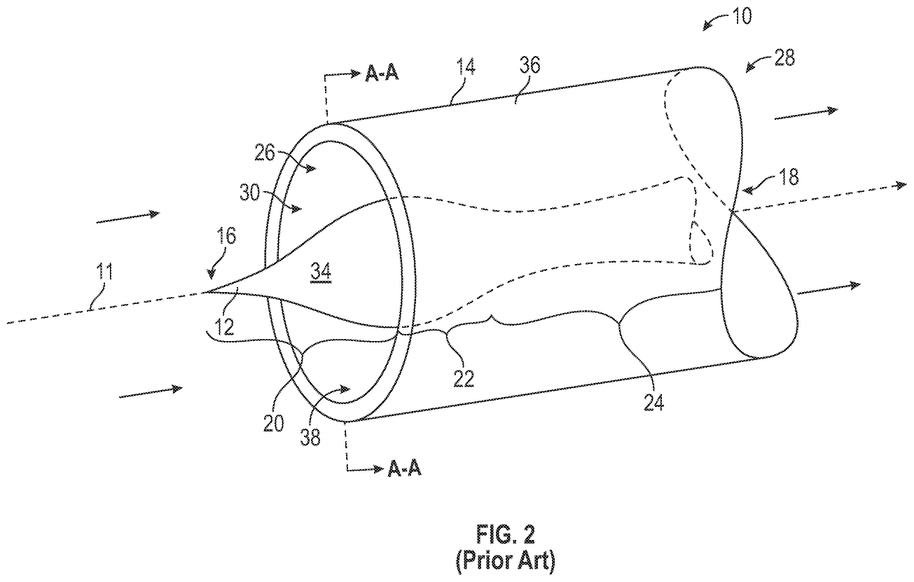

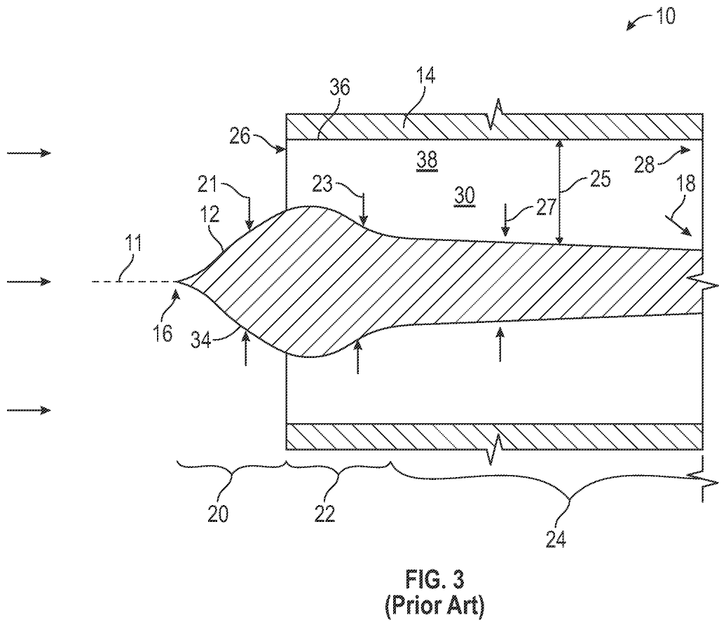

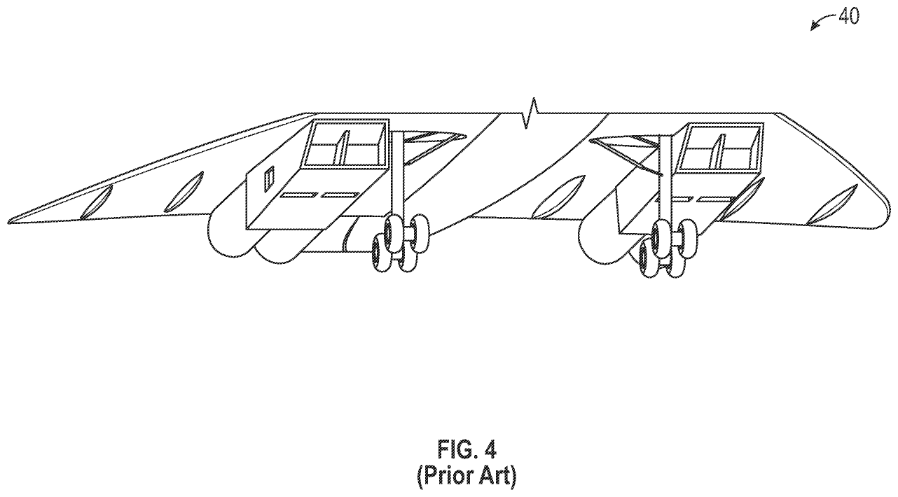

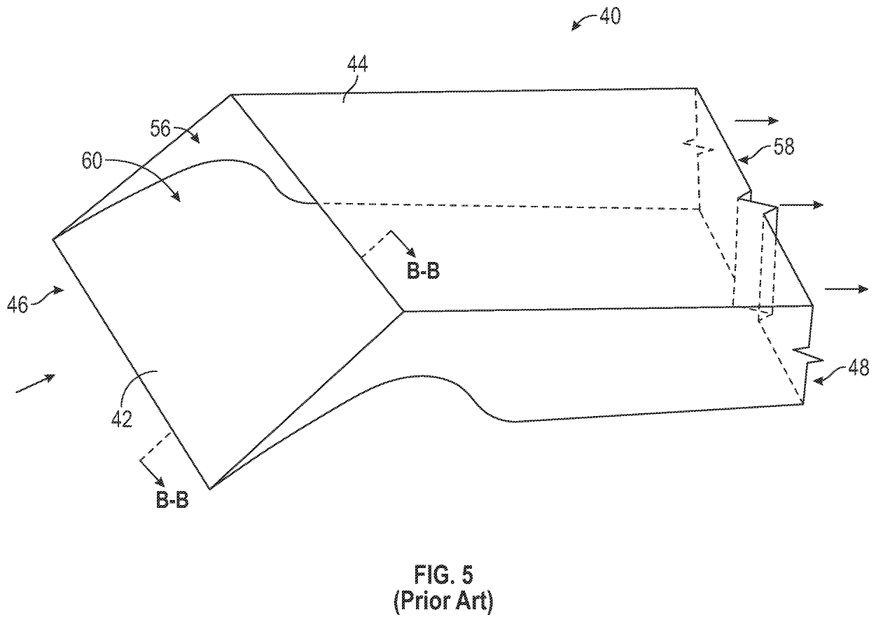

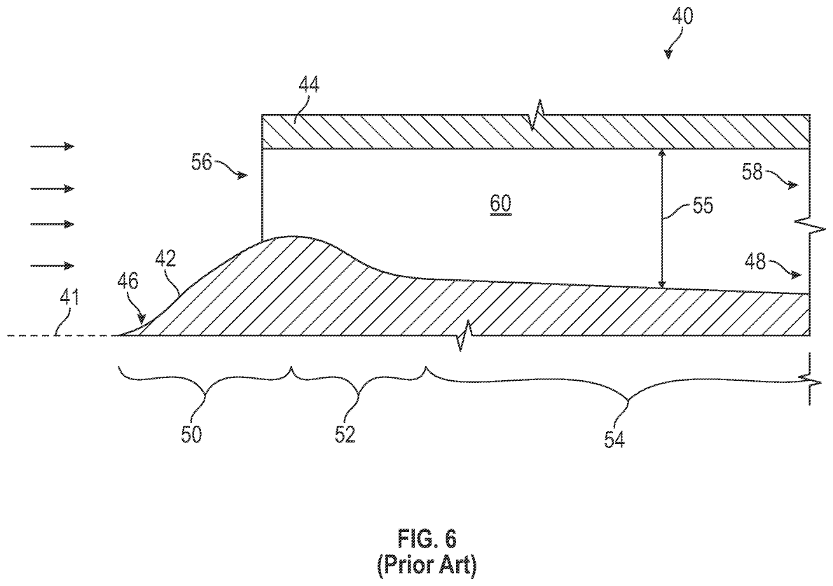

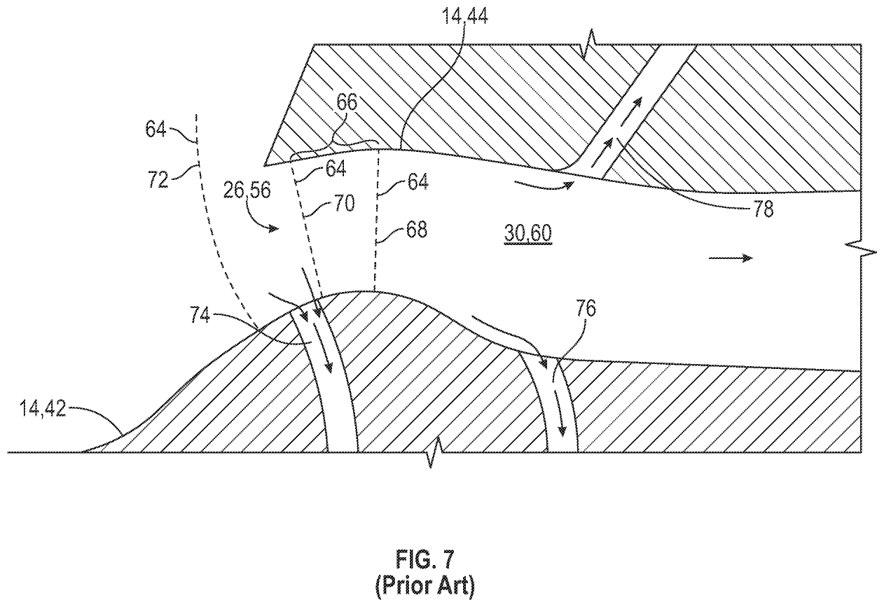

The supersonic inlet systems 100, 200 described herein are considered advantageous at least because they provide a mechanism for stabilizing the normal shock wave of the supersonic inlet through use of a passageway, passageway openings, a compressor, and/or a created co-flow jet. For example, a compressor included in a supersonic inlet system can be controlled to manipulate and/or stabilize an inlet at critical condition, as shown in FIG. 8. The supersonic inlet systems 100, 200 described herein stabilize the inlet normal shock wave at the critical flow condition with large margin to resist various perturbations, such as variation of angle of attack, flow speed, downstream disturbances, etc. In addition, the features included in the supersonic inlet systems 100, 200 described herein have an overall weight that is less than conventional inlet systems, such as those described in FIGS. 1 through 7.

One distinction between the supersonic inlet systems described herein and conventional systems, such as those shown in FIGS. 1 through 7, is that the air flow withdrawn in systems described herein is put back into the system (e.g., a channel) and into a propulsion system (e.g., engine), resulting in a self-contained system with no mass flow loss (e.g., a zero-net-mass-flux flow control) achieving high system efficiency. Whereas, in conventional inlet systems, the bleed technique results in mass flow loss. Furthermore, controlling the amount of mass flow of a created co-flow jet, such as those describe herein, and the injection strength (e.g., mass flow and velocity of fluid exiting the passageway at the discharge port and/or the second passageway opening and/or third passageway opening) can control the normal shock position. A large mass flow withdrawn into a passageway will move the shock wave downstream towards a supercritical position, depending on the position of the initial shock wave. An optimal amount of co-flow (e.g., mass flow and velocity of fluid exiting the passageway at the discharge port and/or the second passageway opening and/or third passageway opening) is capable of stabilizing the shock wave at the optimal position resulting in minimum energy loss.

As shown in FIG. 8, the inlet working condition is categorized by the position of a normal shock wave 280. If the normal shock wave 280 is positioned downstream of an inlet 130 (within a throat portion 149), as shown by line 281, the working condition is a supercritical condition. If the normal shock wave 280 is at an inlet 130, as shown by line 282, the working condition is a critical condition. If the normal shock wave 280 is positioned upstream of an inlet 130, as shown by line 283, the working condition is a subcritical condition. To increase efficiency, the inlet 130 should be stable at the critical condition, which can be accomplished using the inlet system 100 described herein.

As shown in FIG. 9, the inlet working condition is categorized by the position of a normal shock wave 286. If the normal shock wave 286 is positioned downstream of an inlet 230 (within a throat portion 249), as shown by line 287, the working condition is a supercritical condition. If the normal shock wave 286 is at an inlet 230, as shown by line 288, the working condition is a critical condition. If the normal shock wave 286 is positioned upstream of an inlet 230, as shown by line 289, the working condition is a subcritical condition. To increase efficiency, the inlet 230 should be stable at the critical condition, which can be accomplished using the inlet system 200 described herein.

The supersonic inlet systems described herein can be used on, and can be implemented on, any aircraft (e.g., airplane, manned or unmanned, missiles, space transportation vehicles, etc.) that can achieve a flight speed greater than the speed of sound (e.g., M=V/a>1, where M is the Mach number, V is the flight velocity, and a is the speed of sound). While the inlet systems described herein have been described as supersonic inlet systems, the inlet systems described herein can be used on any suitable inlet system. For example, the inlet systems described herein can be used on inlets and ducts to remove flow separation.

Those with ordinary skill in the art will appreciate that various modifications and alternatives for the described and illustrated embodiments can be developed in light of the overall teachings of the disclosure, and that the various elements and features of one example described and illustrated herein can be combined with various elements and features of another example without departing from the scope of the invention. Accordingly, the particular arrangement of elements disclosed herein have been selected by the inventor(s) simply to describe and illustrate examples of the invention and are not intended to limit the scope of the invention or its protection, which is to be given the full breadth of the appended claims and any and all equivalents thereof.

What is claimed is:

1. An inlet system comprising:
a first wall having a first end, a second end, and defining a passageway, a first passageway opening, and a second passageway opening, the passageway extending from the first passageway opening to the second passageway opening;
a second wall, the first wall and the second wall cooperatively defining an inlet, an outlet, and a channel, the channel extending from the inlet to the outlet; and
a compressor disposed within the passageway and configured to pressurize fluid that passes through the passageway;
wherein the first end of the first wall is disposed outside of the channel; and
wherein the passageway is in fluid communication with the channel.

2. The inlet system of claim 1, wherein said inlet system is a supersonic inlet system for an engine.

3. The inlet system of claim 2, wherein the outlet is in fluid communication with an engine.

4. The inlet system of claim 3, wherein said inlet system is an axisymmetric inlet system.

5. The inlet system of claim 3, wherein said inlet system is a rectangular inlet system.

6. The inlet system of claim 1, wherein the first wall has a first portion, a second portion, and a third portion, the first portion extending toward the second wall from the first end of the first wall to the second portion, the second portion extending away from the second wall from the first portion to the third portion, the third portion disposed at a distance from the second wall that increases from the second portion towards the second end of the first wall.

7. The inlet system of claim 1, wherein the first passageway opening has a first cross-sectional area; and
wherein the second passageway opening has a second cross-sectional area that is less than the first cross-sectional area.

8. The inlet system of claim 1, wherein the first passageway opening has a first width;
wherein the second passageway opening has a second width;
wherein the first width is between about 0.01% h and about 10 h where h is an inlet height; and
wherein the second width is between about 0.01% h and about 20 h where h is the inlet height.

9. The inlet system of claim 1, wherein the first wall defines an inner surface; and
wherein the first passageway opening is defined on the inner surface between the first end of the first wall and the second passageway opening.

10. The inlet system of claim 1, wherein the first wall defines an inner surface; and
wherein the first passageway opening is disposed adjacent to the inlet and tangential to the inner surface.

11. The inlet system of claim 1, wherein the first wall defines an inner surface; and
wherein the second passageway opening is defined on the inner surface between the first passageway opening and the second end of the first wall.

12. The inlet system of claim 1, wherein the second passageway opening is separated from the first passageway opening by a distance between about 0.1 h and about 50 h where h is an inlet height.

13. The inlet system of claim 1, wherein the first passageway opening comprises a first plurality of passageway openings.

14. The inlet system of claim 1, wherein the second passageway opening comprises a second plurality of passageway openings.

15. The inlet system of claim 1, wherein the first wall defines an inner surface; and
wherein the second passageway opening is disposed at a first angle relative to the inner surface, the first angle being between about 0 degrees and about 90 degrees.

16. The inlet system of claim 1, wherein the compressor is a micro-compressor.

17. The inlet system of claim 1, wherein the compressor is moveable between an on state and an off state; and
wherein fluid passing through the passageway when the compressor is in the on state has a mass flow rate between about 0.1% and about 5% of a mass flow rate of fluid flowing through the inlet.

18. The inlet system of claim 1, wherein the first wall defines a third passageway opening in fluid communication with the passageway.

19. A supersonic inlet system for an engine comprising:
a first wall having a first end, a second end, and defining an inner surface, a passageway, a first passageway opening, and a second passageway opening, the passageway extending from the first passageway opening to the second passageway opening, the first passageway opening defined on the inner surface between the first end of the first wall and the second passageway opening, the second passageway opening defined on the inner surface between the first passageway opening and the second end of the first wall;
a second wall, the first wall and the second wall cooperatively defining an inlet, an outlet, and a channel, the channel extending from the inlet to the outlet; and
a compressor disposed within the passageway and configured to pressurize fluid that passes through the passageway;
wherein the first end of the first wall is disposed outside of the channel; and
wherein the passageway is in fluid communication with the channel.

20. An inlet system for an engine comprising:
a first wall having a first end, a second end, and defining an inner surface, a passageway, a first passageway opening, and a second passageway opening, the passageway extending from the first passageway opening to the second passageway opening, the first passageway opening defined on the inner surface between the first end of the first wall and the second passageway opening, the second passageway opening defined on the inner surface between the first passageway opening and the second end of the first wall; and
a second wall, the first wall and the second wall cooperatively defining an inlet, an outlet, and a channel, the channel extending from the inlet to the outlet;
wherein the first end of the first wall is disposed outside of the channel; and
wherein the passageway is in fluid communication with the channel.
